(19) United States
(12) Patent Application Publication
(10) Pub. No.: US 2009/0114511 A1
(43) Pub. Date: May 7, 2009

(54) Cogged belt

(75) Inventor: Antonio Pons SANCHEZ, Sant Just Desvern (ES)

Correspondence Address: YOUNG & THOMPSON, 209 Madison Street, Suite 500, ALEXANDRIA, VA, 22314, US

(73) Assignee: TPT MECTROL, S.L., Sant Just Desvern (ES)

(21) Appl. No.: 12/105,344

(22) Filed: Apr. 18, 2008

(30) Foreign Application Priority Data
Apr. 20, 2007 (ES) U 200700763

(51) Int. Cl. B65G 15/46

(52) U.S. Cl. 198/844.1

(57) ABSTRACT

“Improved cogged belt,” of the type used as a conveyor belt, whereby its inner face is equipped with transverse traction teeth, characterized by the fact that, in the spaces between said traction teeth, the belt has a number of secondary teeth, which are preferably perpendicular to the traction teeth, are shorter than the traction teeth, and are intended to ensure automatic centering of the belt on the pulley(s) on which it is used.

### FIELD OF THE INVENTION

The subject of this invention, as stated in the preamble to this specification, refers to an improved cogged belt of the type that is preferably used as a conveyor belt although, optionally, it can also be used in installations that need to use it as a power transmission belt.

### BACKGROUND OF THE INVENTION

Traditionally, when a belt is used as a conveyor belt, it is placed between two or more pulleys and travels on some type of sliding or rolling surface (based on bearings or similar devices).

The method by which mechanical energy is transmitted between the pulleys and the belt is based on at least one of the pulleys being the drive pulley and transmitting the energy to the belt; the belt is subject to a certain amount of tensile stress such that the coefficient of friction is sufficient to ensure that the belt does not slip on the pulley(s), rims, or heads, particularly those that are supposed to maintain the necessary physical contact to provide for an adequate transfer of energy.

The belts currently on the market have different outlines depending on the type of pulley or rim with which they have to mate: square, rectangular, trapezoidal, etc.

The belts can also have smooth or striated surfaces. Transmission belts with inner striated surfaces (whereby the striations are either longitudinal or transverse) are used to improve certain belt operating conditions.

A conveyor belt or strip that has an inner surface that has longitudinal striations or threading is basically designed to be used on open pulleys, rims, or heads, such that, once the belt is properly arranged in its operating position, it will not slip off the heads or guides of the pulleys, rims, or heads. However, the longitudinal striation or threading has, among other things, a serious drawback: in cases where the belt has to exert large forces to drag heavy weights, the belt can wind up slipping on the power transmission pulley. Part of this problem can be solved by increasing the tension on the belt, but this too is a disadvantage since the pulley bearings will undergo accelerated wear and tear and, in addition, the extra tension on the belt or strip will increase the risk of rupture.

However, a belt that has an inner surface with transverse striations, i.e., a belt that consists of “teeth”, has the advantage of solving the problem of slippage, but it has the drawback that it can be used only on closed pulleys, rims, or heads since otherwise the belt will wind up slipping off its guide.

One solution to this problem consists in ensuring that, in some installations, the conveyor belts or strips travel between lateral guides (or “flanges”) that ensure that the belt does not slip off the track, but this solution has a drawback in that these lateral guides can cause fretting of or damage to the equipment or devices that carry the conveyor belt or strip.

### DESCRIPTION OF THE INVENTION

In order to correct these deficiencies, a novel improved cogged belt has been designed for use as a conveyor belt, which is the subject of this technical description.

The novel belt or strip is made in such a way that it does not require that the above-described lateral guides be present to keep the belt from slipping off the track; rather, on its inner face it has a number of secondary longitudinal guides or teeth.

The novel improved cogged belt, of the type used as a conveyor belt, was made in such a way that its inner face is equipped with a number of transverse traction teeth; in the spaces between said traction teeth, the belt also has a number of secondary teeth, which are preferably perpendicular to the traction teeth, are shorter than the traction teeth, and are intended to ensure the belt is automatically centered on the pulley(s) on which it is used.

The secondary teeth are preferably triangular in cross-section.

### DESCRIPTION OF THE DRAWINGS

In order to illustrate the material presented above, a set of drawings is attached to this specification and is an integral part thereof; these drawings show, in a simplified and schematic manner, an embodiment, which is solely illustrative in nature and is non-limiting, of the characteristics of the novel invention.

FIG. 1 shows an overall perspective view of the new conveyor belt.

FIG. 2 shows a detail of the inside of the belt, corresponding to the area illustrated in FIG. 1.

### DESCRIPTION OF AN EMBODIMENT

The figures that are attached to this document show, by way of example, an embodiment of the device that is the subject of the document.

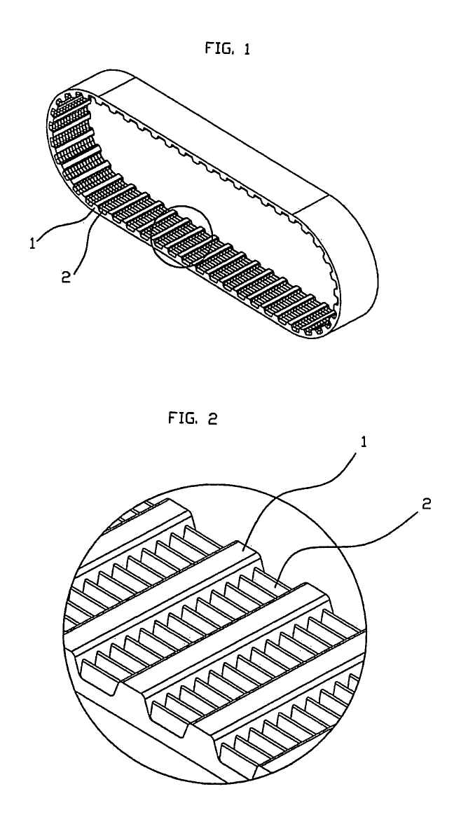

The novel improved cogged belt, of the type used as a conveyor belt, was made in such a way that its inner face is equipped with a number of transverse traction teeth (FIG. 1); in the spaces between said traction teeth, the belt also has a number of secondary teeth (FIG. 2), which are preferably perpendicular to the traction teeth, are shorter than the traction teeth (FIG. 1), and are intended to ensure automatic centering of the belt on the pulley(s) on which it is used.

In this embodiment the secondary teeth (FIG. 2) are preferably triangular in cross-section.

The materials that are used to make the various parts of this invention, as well as the shapes, dimensions, and accessories that said invention may have, are immaterial to the subject of this invention; these materials may be replaced with others that are technically equivalent, provided that they do not affect the essence of the patent or exceed the scope defined in the Claims section.

1. “Improved cogged belt,” of the type used as a conveyor belt, whereby its inner face is equipped with transverse traction teeth (FIG. 1), characterized by the fact that, in the spaces between said traction teeth, the belt has a number of secondary teeth (FIG. 2), which are preferably perpendicular to the traction teeth, are shorter than the traction teeth (FIG. 1), and are intended to ensure automatic centering of the belt on the pulley(s) on which it is used.

2. “Improved cogged belt” of claim 1, wherein the secondary teeth (FIG. 2) are preferably triangular in cross-section.
